(19) United States
(12) Patent Application Publication
(10) Pub. No.: US 2020/0057326 A1
(43) Pub. Date: Feb. 20, 2020

(54) LIQUID CRYSTAL DISPLAY PANEL

(71) Applicant: Chunghwa Picture Tubes, LTD., Taoyuan City (TW)

(72) Inventor: Min-Ta Lai, Taoyuan City (TW)

(73) Assignee: Chunghwa Picture Tubes, LTD., Taoyuan City (TW)

(21) Appl. No.: 16/177,457

(22) Filed: Nov. 1, 2018

(30) Foreign Application Priority Data
Aug. 20, 2018 (CN) 201810959779.8

(51) Int. Cl. G02F 1/1339; G02F 1/1343; G02F 1/1335; G02F 1/1333

(52) U.S. Cl. CPC G02F 1/1339; G02F 1/133345; G02F 1/133514; G02F 1/1343

(57) ABSTRACT

A liquid crystal display panel including a pixel array substrate, an opposite substrate, a liquid crystal layer, a plurality of first bumps, a first inorganic transparent insulating layer and a sealant is provided. The opposite substrate faces the pixel array substrate. The liquid crystal layer is located between the pixel array substrate and the opposite substrate. The plurality of first bumps are located between the pixel array substrate and the opposite substrate. The first inorganic transparent insulating layer is located on the plurality of first bumps and completely covers the opposite substrate. The sealant surrounds the liquid crystal layer. The sealant covers the plurality of first bumps. The liquid crystal display panel of the disclosure effectively blocks the moisture infiltrating from the sealant.

### CROSS-REFERENCE TO RELATED APPLICATION

This application claims the priority benefit of China application serial no. 201810959779.8, filed on Aug. 20, 2018. The entirety of the above-mentioned patent application is hereby incorporated by reference herein and made a part of this specification.

### BACKGROUND OF THE INVENTION

### Field of the Invention

The disclosure relates to a liquid crystal display panel having a sealant covering a first bump.

### Description of Related Art

In general, the liquid crystal display includes an upper substrate, a lower substrate and a liquid crystal located between the upper and lower substrates. The sealant is applied to bond the upper and lower substrates and to prevent the liquid crystal layer from contacting with the external environment, serving as a defense of the liquid crystal display that blocks moisture.

However, as the common sealant is made of a polymer material, in the environment of high temperature and high humidity, moisture still has the opportunity to pass through the sealant and cause damage to the liquid crystal layer. In addition, the market share of the display with a narrow frame is gradually increasing for having a greater screen-to-body ratio. However, since the display with a narrow frame has a rather small space between the display region and the edge of the substrate, the space for coating the sealant is also small, which affects the adhesion of the upper and lower substrates and the performance of the sealant to prevent the moisture from infiltrating.

### SUMMARY OF THE INVENTION

The disclosure relates to a liquid crystal display panel having a sealant covering a first bump.

According to an embodiment of the disclosure, a liquid crystal display panel includes a pixel array substrate, an opposite substrate, a liquid crystal layer, a first bump, a first inorganic transparent insulating layer and a sealant. The opposite substrate faces the pixel array substrate. The liquid crystal layer is located between the pixel array substrate and the opposite substrate. The first bump is located between the pixel array substrate and the opposite substrate. The first inorganic transparent insulating layer is located on the first bump and completely covers the opposite substrate. The sealant surrounds the liquid crystal layer. The sealant covers the first bump.

In an embodiment of the disclosure, the first bump is located on the opposite substrate and the first bump protrudes from the opposite substrate toward the pixel array substrate.

In an embodiment of the disclosure, the liquid crystal display panel further includes a second bump and a second inorganic transparent insulating layer. The second bump is located on the pixel array substrate, and the second bump protrudes from the pixel array substrate toward the opposite substrate, wherein the sealant covers the second bump. The second inorganic transparent insulating layer is located on the second bump.

In an embodiment of the disclosure, the liquid crystal display panel further includes a second inorganic transparent insulating layer located on the pixel array substrate.

In an embodiment of the disclosure, the liquid crystal display panel further includes a pixel electrode and a common electrode, located on the pixel array substrate, wherein the second inorganic transparent insulating layer is located between the pixel electrode and the common electrode.

In an embodiment of the disclosure, the first inorganic transparent insulating layer contacts the second inorganic transparent insulating layer.

In an embodiment of the disclosure, the first inorganic transparent insulating layer does not contact the second inorganic transparent insulating layer.

In an embodiment of the disclosure, the liquid crystal display panel further includes a first color resist, located on the opposite substrate and including a plurality of first sub-pixel filter patterns and a first isolation structure; a second color resist, located on the opposite substrate and including a plurality of second sub-pixel filter patterns and a second isolation structure, wherein the first bump includes the first isolation structure and the second isolation structure stacked on each other; and a third color resist, located on the opposite substrate and including a plurality of third sub-pixel filter patterns.

In an embodiment of the disclosure, the third color resist further includes a third isolation structure, wherein the first bump includes the first isolation structure, the second isolation structure and the third isolation structure stacked on each other.

In an embodiment of the disclosure, a distance between an end of the first isolation structure and a corresponding end of the corresponding second isolation structure is equal to a distance between an end of each of the first sub-pixel filter patterns and a corresponding end of a corresponding second sub-pixel filter pattern, and a distance between an end of each of the second isolation structures and a corresponding end of the corresponding third isolation structure is equal to a distance between an end of each of the plurality of second sub-pixel filter patterns and a corresponding end of a corresponding third sub-pixel filter pattern.

In an embodiment of the disclosure, the first inorganic transparent insulating layer includes silicon nitride or silicon oxide.

Based on the above, by having the first inorganic transparent insulating layer located on the first bump, and having the sealant covering the first bump, not only the moisture is effectively blocked from infiltrating from the sealant, but also the bonding area of the sealant increases and the adhesion of the sealant is improved.

In order to make the aforementioned and other features and advantages of the disclosure more comprehensible, several embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic top view of a liquid crystal display panel according to an embodiment of the disclosure.

FIG. 2 is a schematic cross-sectional view along the line AA′ of FIG. 1.

FIG. 3 is a schematic cross-sectional view of a liquid crystal display panel according to an embodiment of the disclosure.

FIG. 4 is a schematic cross-sectional view of a liquid crystal display panel according to an embodiment of the disclosure.

FIG. 5 is a schematic cross-sectional view of a liquid crystal display panel according to an embodiment of the disclosure.

FIG. 6 is a schematic cross-sectional view of a liquid crystal display panel according to an embodiment of the disclosure.

FIG. 7 is a schematic cross-sectional view of a liquid crystal display panel according to an embodiment of the disclosure.

FIG. 8 is a schematic cross-sectional view of a liquid crystal display panel according to an embodiment of the disclosure.

### DESCRIPTION OF THE EMBODIMENTS

Descriptions of the disclosure are given with reference to the exemplary embodiments illustrated by the figures. Wherever possible, the same reference numerals are used in the figures and the description to refer to the same or similar parts.

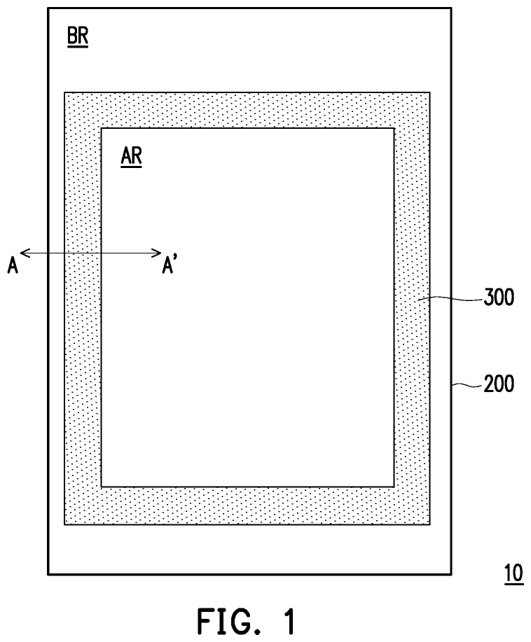

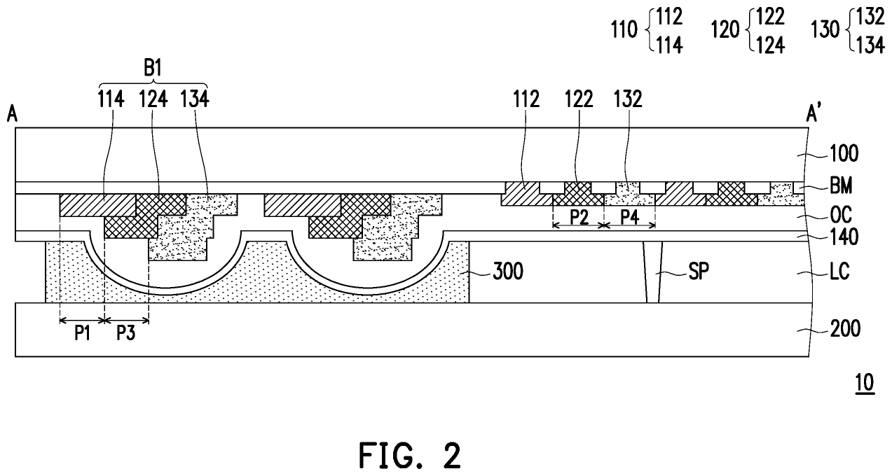

FIG. 1 is a schematic top view of a liquid crystal display panel according to an embodiment of the disclosure, and FIG. 2 is a schematic cross-sectional view along the line AA′ of FIG. 1. FIG. 1 illustrates a pixel array substrate 200 and a sealant 300, and other components are omitted.

Referring to FIG. 1 and FIG. 2, a liquid crystal display panel 10 includes a pixel array substrate 200, an opposite substrate 100, a liquid crystal layer LC, a plurality of first bumps B1, a first inorganic transparent insulating layer 140 and a sealant 300. The opposite substrate 100 faces the pixel array substrate 200. The liquid crystal display panel 10 has an active region AR and a peripheral region BR surrounding the active region AR. The liquid crystal layer LC is located between the pixel array substrate 200 and the opposite substrate 100 and is located in the active region AR. The sealant 300 surrounds the liquid crystal layer LC. In this embodiment, the liquid crystal display panel 10 optionally includes a spacer SP. The spacer SP is located between the pixel array substrate 100 and the opposite substrate 300, for example, and may be adapted to control a thickness of the liquid crystal layer LC.

In this embodiment, the opposite substrate 100 is a color filter element substrate. The opposite substrate 100 has a black matrix BM, a first color resist 110, a second color resist 120, a third color resist 130 and an over coating layer OC. The black matrix BM, the first color resist 110, the second color resist 120 and the third color resist 130 are located on the opposite substrate 100. The first color resist 110, the second color resist 120 and the third color resist 130 are color resists of different colors. The first color resist 110, the second color resist 120 and the third color resist 130 are, for example, a red color resist, a green color resist, and a blue color resist, respectively.

The first color resist 110 includes a plurality of first sub-pixel filter patterns 112 and at least one first isolation structure 114. The second color resist 120 includes a plurality of second sub-pixel filter patterns 122 and at least one second isolation structure 124. The third color resist 130 includes a plurality of third sub-pixel filter patterns 132 and at least one third isolation structure 134. The first sub-pixel filter pattern 112, the second sub-pixel filter pattern 122 and the third sub-pixel filter pattern 132 are, for example, located in the active region AR of the liquid crystal display panel 10. The first isolation structure 114, the second isolation structure 124 and the third isolation structure 134 are, for example, located in the peripheral region BR of the liquid crystal display panel 10.

In this embodiment, the first color resist 110, the second color resist 120 and the third color resist 130 are defined by a same photo mask. Therefore, a distance P1 between an end of the first isolation structure 114 (for example, the left end) and a corresponding end of the corresponding second isolation structure 124 (for example, the left end) is equal to a distance P2 between an end of each of the plurality of first sub-pixel filter patterns 112 (for example, the left end) and a corresponding end of a corresponding second sub-pixel filter pattern 122 (for example, the left end), and a distance P3 between an end of each of the plurality of the second isolation structures 124 (for example, the left end) and a corresponding end of the corresponding third isolation structure 134 (for example, the left end) is equal to a distance P4 between an end of each of the plurality of second sub-pixel filter patterns 122 (for example, the left end) and a corresponding end of a corresponding third sub-pixel filter pattern 132 (for example, the left end).

In this embodiment, a vertical projection area of each of the plurality of the first isolation structures 114 on the opposite substrate 100 is equal to a vertical projection area of each of the plurality of the second isolation structures 124 on the opposite substrate 100 and a vertical projection area of each of the plurality of the third isolation structures 134 on the opposite substrate 100. A vertical projection area of each of the plurality of the first sub-pixel filter patterns 112 on the opposite substrate 100 is equal to a vertical projection area of each of the plurality of the second sub-pixel filter patterns 122 on the opposite substrate 100 and a vertical projection area of each of the plurality of the third sub-pixel filter patterns 132 on the opposite substrate 100.

In this embodiment, the vertical projection area of each of the plurality of the first sub-pixel filter patterns 114 on the opposite substrate 100 is greater than the vertical projection area of each of the plurality of the first sub-pixel filter patterns 112 on the opposite substrate 100 and may be 1.5 times greater than the same, for example. In this embodiment, the vertical projection area of each of the plurality of the second isolation structures 124 on the opposite substrate 100 is greater than the vertical projection area of each of the plurality of the second sub-pixel filter patterns 122 on the opposite substrate 100 and may be 1.5 times greater than the same, for example. In this embodiment, the vertical projection area of each of the plurality of the third isolation structures 134 on the opposite substrate 100 is greater than the vertical projection area of each of the plurality of the third sub-pixel filter patterns 132 on the opposite substrate 100 and may be 1.5 times greater than the same, for example.

At least one first bump B1 is located between the pixel array substrate 200 and the opposite substrate 100. In this embodiment, two first bumps B1 are taken as an example, but the disclosure is not limited thereto. Each first bump B1 includes the first isolation structure 114, the second isolation structure 124 and the third isolation structure 134 stacked on each other. The flatness of the top of the first bump B1 may vary due to the width of the first isolation structure 114, the second isolation structure 124 and the third isolation structure 134.

The first inorganic transparent insulating layer 140 is located on the first bump B1. The first inorganic transparent insulating layer 140 completely covers the opposite substrate 100, for example, substantially covers the entire lower surface of the opposite substrate 100 or the entire inner surface of the opposite substrate 100. The first inorganic transparent insulating layer 140 includes silicon nitride or silicon oxide. In this embodiment, the first inorganic transparent insulating layer 140 and the first bump B1 further have an over coating layer OC in between. The over coating layer OC covers the first color resist 110, the second color resist 120 and the third color resist 130, but the disclosure is not limited thereto. In some embodiments, the thickness of the over coating layer OC affects the shape of the first inorganic transparent insulating layer 140 at the first bump B1. The thinner the over coating layer OC is, the more prominent the reliefs formed by the first inorganic transparent insulating layer 140 at the first bump B1 are.

The pixel array substrate 200 includes, for example, a plurality of scan lines, a plurality of data lines, a plurality of active elements, and a plurality of pixel electrodes thereon. In some embodiments, the pixel array substrate 200 further includes a common electrode thereon, but the disclosure is not limited thereto. In some embodiments, the opposite substrate 100 includes a common electrode thereon.

The sealant 300 is located between the pixel array substrate 200 and the opposite substrate 100, and may be adapted to seal the liquid crystal layer LC. In this embodiment, the sealant 300 covers the first bump B1. The first inorganic transparent insulating layer 140 on a surface of the first bump B1 may block the moisture. As such, the first bump B1 and the first inorganic transparent insulating layer 140 lengthens the moving path required for the moisture to pass through the sealant 300 and thereby makes it more difficult for the moisture to pass through the sealant 300. Hence, the moisture is effectively blocked from infiltrating from the sealant 300. In addition, the first bump B1 increases a bonding area of the sealant 300 and improves the adhesion of the sealant 300.

Based on the above, by having the first inorganic transparent insulating layer 140 located on the first bump B1, and having the sealant 300 covering the first bump B1, not only the moisture is effectively blocked from infiltrating from the sealant 300, but also the bonding area of the sealant 300 increases and the adhesion of the sealant 300 is improved.

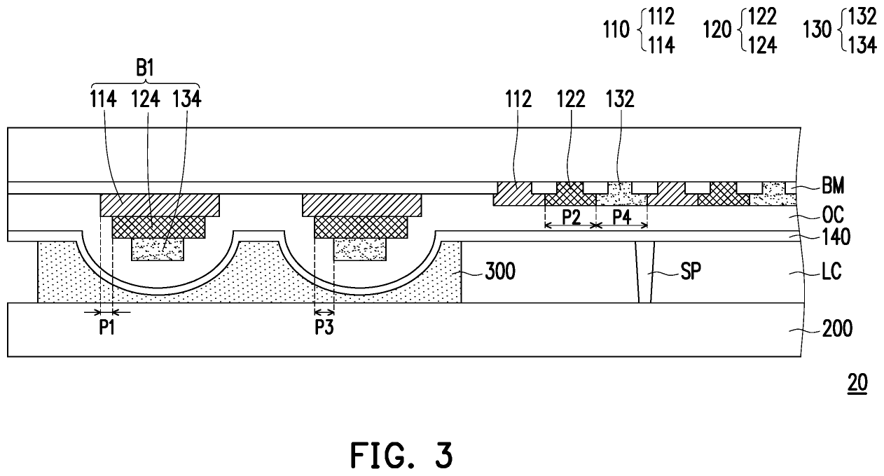

FIG. 3 is a schematic cross-sectional view of a liquid crystal display panel according to an embodiment of the disclosure. It should be noted that the reference numerals and a part of the contents in the embodiments of FIG. 1 to FIG. 2 are also used to describe the embodiments of FIG. 3, in which the same or similar reference numerals are used to represent identical or similar elements, and thus descriptions of the same technical contents are omitted. Please refer to the descriptions of the previous embodiment for the omitted contents, which will not be repeated hereinafter.

The main difference between a liquid crystal display panel 20 of FIG. 3 and the liquid crystal display panel 10 of FIG. 1 lies in: the first color resist 110, the second color resist 120 and the third color resist 130 of the liquid crystal display panel 20 are defined by different photo masks.

Referring to FIG. 3, a distance P1 between an end of the first isolation structure 114 (for example, the left end) and a corresponding end of the corresponding second isolation structure 124 (for example, the left end) is different from a distance P2 between an end of each of the plurality of first sub-pixel filter patterns 112 (for example, the left end) and a corresponding end of a corresponding second sub-pixel filter pattern 122 (for example, the left end), and a distance P3 between an end of each of the plurality of the second isolation structures 124 (for example, the left end) and a corresponding end of the corresponding third isolation structure 134 (for example, the left end) is different from a distance P4 between an end of each of the plurality of second sub-pixel filter patterns 122 (for example, the left end) and a corresponding end of a corresponding third sub-pixel filter pattern 132 (for example, the left end).

In this embodiment, a vertical projection area of each of the plurality of the first isolation structures 114 on the opposite substrate 100 is different from a vertical projection area of each of the plurality of the second isolation structures 124 on the opposite substrate 100 and a vertical projection area of each of the plurality of the third isolation structures 134 on the opposite substrate 100. The vertical projection area of each of the plurality of the second isolation structures 124 on the opposite substrate 100 is different from the vertical projection area of each of the plurality of the third isolation structures 134 on the opposite substrate 100, but the disclosure is not limited thereto.

The width of the first bump B1 may be freely designed, and the first isolation structure 114, the second isolation structure 124 and the third isolation structure 134 are reduced in size sequentially in the order of fabrication. The greater the differences between the widths of the first isolation structure 114, the second isolation structure 124 and the third isolation structure 134 are, the flatter the top of the first bump B1 fabricated is. The smaller the differences between the widths of the first isolation structure 114, the second isolation structure 124 and the third isolation structure 134 are, the steeper the top of the first bump B1 fabricated is.

Based on the above, by having the first inorganic transparent insulating layer 140 located on the plurality of first bumps B1, and having the sealant 300 covering the plurality of first bumps B1, not only the moisture is effectively blocked from infiltrating from the sealant 300, but also the bonding area of the sealant 300 increases and the adhesion of the sealant 300 is improved.

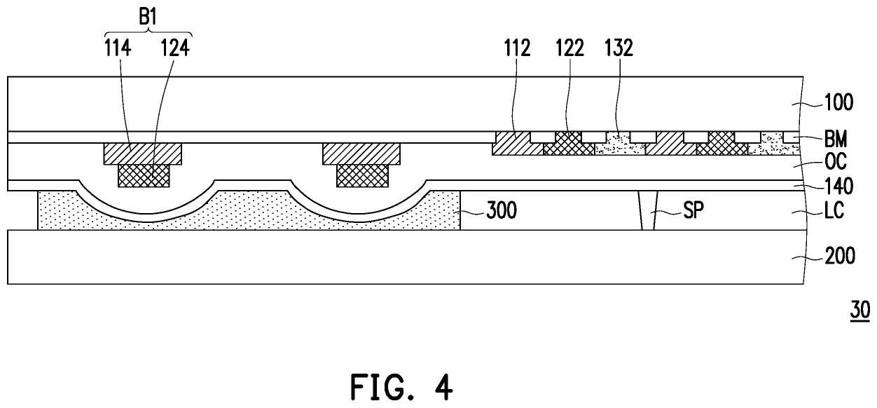

FIG. 4 is a schematic cross-sectional view of a liquid crystal display panel according to an embodiment of the disclosure. It should be noted that the reference numerals and a part of the contents in the embodiments of FIG. 3 are also used to describe the embodiments of FIG. 4, in which the same or similar reference numerals are used to represent identical or similar elements, and thus descriptions of the same technical contents are omitted. Please refer to the descriptions of the previous embodiment for the omitted contents, which will not be repeated hereinafter.

The main difference between a liquid crystal display panel 30 of FIG. 4 and the liquid crystal display panel 20 of FIG. 2 lies in: each first bump B1 includes one of the first isolation structures 114 and one of the second isolation structures 124 stacked on each other.

The first color resist 110 includes a plurality of first sub-pixel filter patterns 112 and at least one first isolation structure 114, the second color resist 120 includes a plurality of second sub-pixel filter patterns 122 and at least one second isolation structure 124, and the third color resist 130 includes a plurality of third sub-pixel filter patterns 132. The first bump B1 includes a first isolation structure 114 and a second isolation structure 124 stacked on each other. In this embodiment, the first color resist 110 includes a plurality of first sub-pixel filter patterns 112 and a plurality of first isolation structures 114, the second color resist 120 includes a plurality of second sub-pixel filter patterns 122 and a plurality of second isolation structures 124, but the disclosure is not limited thereto.

In other embodiments, the first color resist 110 includes a plurality of first sub-pixel filter patterns 112 and at least one first isolation structure 114, the second color resist 120 includes a plurality of second sub-pixel filter patterns 122, and the third color resist 130 includes a plurality of third sub-pixel filter patterns 132 and at least one third isolation structure 134. The first bump B1 includes a first isolation structure 114 and a third isolation structure 134 stacked on each other.

In other embodiments, the first color resist 110 includes a plurality of first sub-pixel filter patterns 112, the second color resist 120 includes a plurality of second sub-pixel filter patterns 122 and at least one second isolation structure 124, and the third color resist 130 includes a plurality of third sub-pixel filter patterns 132 and at least one third isolation structure 134. The first bump B1 includes a second isolation structure 124 and a third isolation structure 134 stacked on each other.

In this embodiment, the first color resist 110, the second color resist 120 and the third color resist 130 are defined by different photo masks, for example, but the disclosure is not limited thereto. In other embodiments, the first color resist 110 and the second color resist 120 are defined by a same photo mask, as the third color resist 130 is defined by a different photo mask. In other embodiments, the second color resist 120 and the third color resist 130 are defined by a same photo mask, as the first color resist 110 is defined by a different photo mask. In other embodiments, the first color resist 110 and the third color resist 130 are defined by a same photo mask, as the second color resist 120 is defined by a different photo mask.

By having each first bump B1 including two of the first isolation structure 114, the second isolation structure 124 and the third isolation structure 134, the thickness of the liquid crystal layer LC may be smaller.

Based on the above, by having the first inorganic transparent insulating layer 140 located on the first bump B1, and having the sealant 300 covering the first bump B1, not only the moisture is effectively blocked from infiltrating from the sealant 300, but also the bonding area of the sealant 300 increases and the adhesion of the sealant 300 is improved.

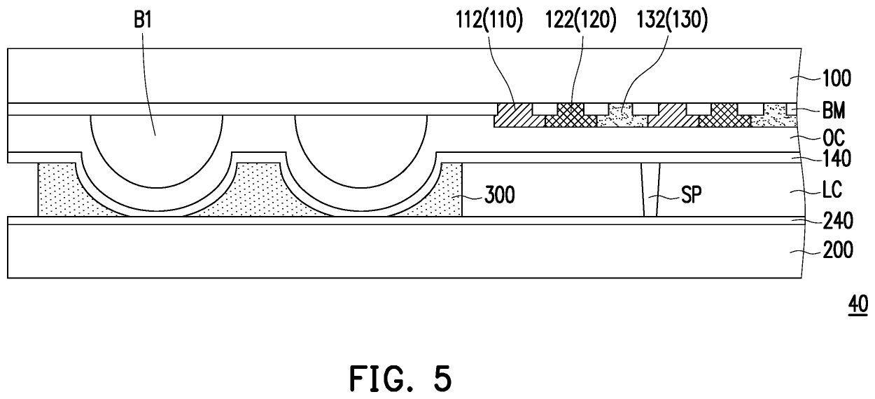

FIG. 5 is a schematic cross-sectional view of a liquid crystal display panel according to an embodiment of the disclosure. It should be noted that the reference numerals and a part of the contents in the embodiments of FIG. 1 to FIG. 2 are also used to describe the embodiments of FIG. 5, in which the same or similar reference numerals are used to represent identical or similar elements, and thus descriptions of the same technical contents are omitted. Please refer to the descriptions of the previous embodiment for the omitted contents, which will not be repeated hereinafter.

The main difference between a liquid crystal display panel 40 of FIG. 5 and the liquid crystal display panel 10 of FIG. 1 lies in: the liquid crystal display panel 40 further includes a second inorganic transparent insulating layer 240.

In this embodiment, the first bump B1 may be the same as the first bump B1 of any of the foregoing embodiments. For example, the first bump B1 includes at least two of the first isolation structure 114, the second isolation structure 124 and the third isolation structure 134 of the foregoing embodiments, but the disclosure is not limited thereto. The first bump B1 may also be made of other materials.

In this embodiment, the second inorganic transparent insulating layer 240 is located on the pixel array substrate 200. In some embodiments, the second inorganic transparent insulating layer 240 completely covers the pixel array substrate 200, for example, substantially covers the entire upper surface of the pixel array substrate 200 or the entire inner surface of the pixel array substrate 200, but the disclosure is not limited thereto. The first inorganic transparent insulating layer 140 is in contact with the second inorganic transparent insulating layer 240, blocking the path of the moisture to infiltrate into the liquid crystal display panel 40.

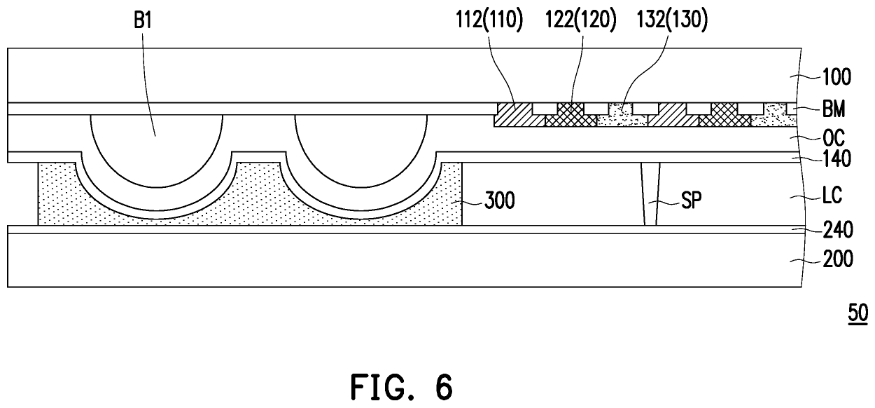

FIG. 6 is a schematic cross-sectional view of a liquid crystal display panel according to an embodiment of the disclosure. It should be noted that the reference numerals and a part of the contents in the embodiments of FIG. 5 are also used to describe the embodiments of FIG. 6, in which the same or similar reference numerals are used to represent identical or similar elements, and thus descriptions of the same technical contents are omitted. Please refer to the descriptions of the previous embodiment for the omitted contents, which will not be repeated hereinafter.

The main difference between a liquid crystal display panel 50 of FIG. 6 and the liquid crystal display panel 40 of FIG. 5 lies in: The first inorganic transparent insulating layer 140 of the liquid crystal display panel 50 does not contact the second inorganic transparent insulating layer 240.

In this embodiment, since the first inorganic transparent insulating layer 140 does not contact the second inorganic transparent insulating layer 240, a contact area between the sealant 300 and the second inorganic transparent insulating layer 240 on the pixel array substrate 200 and a contact area between the sealant 300 and the first inorganic transparent insulating layer 140 on the opposite substrate 100 are larger.

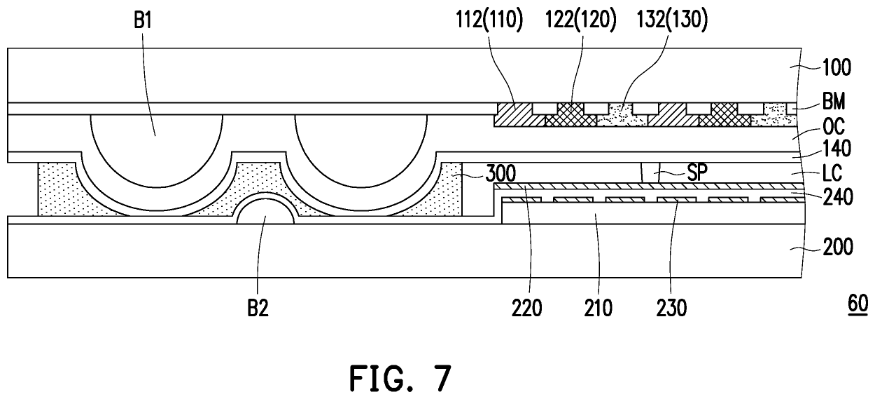

FIG. 7 is a schematic cross-sectional view of a liquid crystal display panel according to an embodiment of the disclosure. It should be noted that the reference numerals and a part of the contents in the embodiments of FIG. 5 are also used to describe the embodiments of FIG. 7, in which the same or similar reference numerals are used to represent identical or similar elements, and thus descriptions of the same technical contents are omitted. Please refer to the descriptions of the previous embodiment for the omitted contents, which will not be repeated hereinafter.

The main difference between a liquid crystal display panel 60 of FIG. 7 and the liquid crystal display panel 40 of FIG. 5 lies in: the liquid crystal display panel 60 further includes a plurality of second bumps B2.

In this embodiment, an active region AR of the liquid crystal display panel 60 (as shown in FIG. 1) has an insulating layer 210, and a peripheral region BR (as shown in FIG. 1) has a plurality of second bumps B2. The insulating layer 210 is located on the pixel array substrate 200. The second bumps B2 are located on the pixel array substrate 200. The second bumps B2 and the insulating layer 210 are formed by the same material and are formed together, for example.

At least one of the second bumps B2 protrudes from the pixel array substrate 200 toward the opposite substrate 100, wherein the sealant 300 covers at least one of the second bumps B2. The second inorganic transparent insulating layer 240 is located on the second bumps B2. In this embodiment, the plurality of second bumps B2 are covered by the sealant 300, for example, but the disclosure is not limited thereto.

In this embodiment, the second bumps B2 and the first bumps B1 are disposed alternately, but the disclosure is not limited thereto. In other embodiments, the second bumps B2 and the first bumps B1 may be connected to one another.

In this embodiment, the active region AR of the liquid crystal display panel 60 has a pixel electrode 220 and a common electrode 230 therein. The pixel electrode 220 and the common electrode 230 are located on the pixel array substrate 200, and the pixel electrode 220 and the common electrode 230 are, for example, located on the insulating layer 210. The second inorganic transparent insulating layer 240 is located between the pixel electrode 220 and the common electrode 230.

Based on the above, by having the first inorganic transparent insulating layer 140 located on the plurality of first bumps B1, having the second inorganic transparent insulating layer 240 located on the plurality of second bumps B2, and having the sealant 300 covering the plurality of first bumps B1 and the plurality of second bumps B2, not only the moisture is effectively blocked from infiltrating from the sealant 300, but also the bonding area of the sealant 300 increases and the adhesion of the sealant 300 is improved.

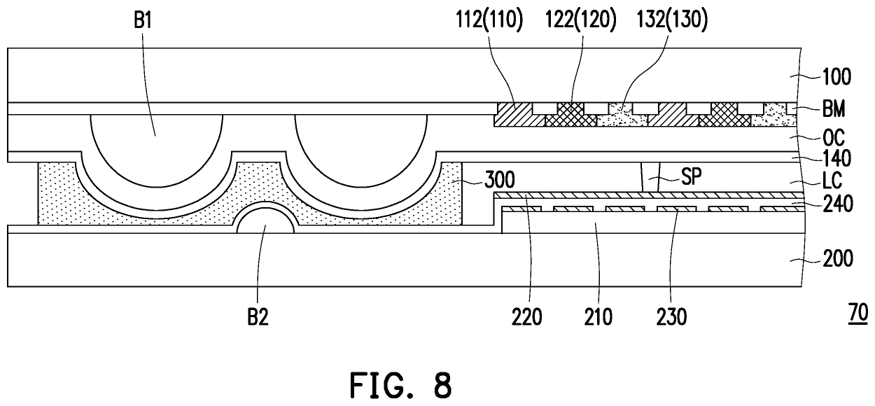

FIG. 8 is a schematic cross-sectional view of a liquid crystal display panel according to an embodiment of the disclosure. It should be noted that the reference numerals and a part of the contents in the embodiments of FIG. 7 are also used to describe the embodiments of FIG. 8, in which the same or similar reference numerals are used to represent identical or similar elements, and thus descriptions of the same technical contents are omitted. Please refer to the descriptions of the previous embodiment for the omitted contents, which will not be repeated hereinafter.

The main difference between a liquid crystal display panel 70 of FIG. 8 and the liquid crystal display panel 60 of FIG. 7 lies in: The first inorganic transparent insulating layer 140 of the liquid crystal display panel 70 does not contact the second inorganic transparent insulating layer 240.

In this embodiment, since the first inorganic transparent insulating layer 140 does not contact the second inorganic transparent insulating layer 240, a contact area between the sealant 300 and the second inorganic transparent insulating layer 240 on the pixel array substrate 200 and a contact area between the sealant 300 and the first inorganic transparent insulating layer 140 on the opposite substrate 100 are larger.

In sum of the above, by having the first inorganic transparent insulating layer located on the first bump, and having the sealant covering the first bump, not only the moisture is effectively blocked from infiltrating from the sealant, but also the bonding area of the sealant increases and the adhesion of the sealant is improved. In some embodiments, the liquid crystal display panel further includes a second inorganic transparent insulating layer and a second bump. The second inorganic transparent insulating layer is located on the second bump, and the sealant covers the first bump and the second bump. As such, not only the moisture is more effectively blocked from infiltrating from the sealant, but also the bonding area of the sealant further increases and the adhesion of the sealant is improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A liquid crystal display panel, comprising:
a pixel array substrate;
an opposite substrate, facing the pixel array substrate;
a liquid crystal layer, located between the pixel array substrate and the opposite substrate;
a first bump, located between the pixel array substrate and the opposite substrate;
a first inorganic transparent insulating layer, located on the first bump and completely covering the opposite substrate; and
a sealant, surrounding the liquid crystal layer, wherein the sealant covers the first bump.

2. The liquid crystal display panel according to claim 1, wherein the first bump is located on the opposite substrate and the first bump protrudes from the opposite substrate toward the pixel array substrate.

3. The liquid crystal display panel according to claim 2, further comprising:
a second bump, located on the pixel array substrate, and the second bump protrudes from the pixel array substrate toward the opposite substrate, wherein the sealant covers the second bump; and
a second inorganic transparent insulating layer located on the second bump.

4. The liquid crystal display panel according to claim 1, further comprising:
a second inorganic transparent insulating layer, located on the pixel array substrate.

5. The liquid crystal display panel according to claim 4, further comprising:
a pixel electrode and a common electrode, located on the pixel array substrate, wherein the second inorganic transparent insulating layer is located between the pixel electrode and the common electrode.

6. The liquid crystal display panel according to claim 4, wherein the first inorganic transparent insulating layer contacts the second inorganic transparent insulating layer.

7. The liquid crystal display panel according to claim 4, wherein the first inorganic transparent insulating layer does not contact the second inorganic transparent insulating layer.

8. The liquid crystal display panel according to claim 1, further comprising:
a first color resist, located on the opposite substrate and comprising a plurality of first sub-pixel filter patterns and a first isolation structure;
a second color resist, located on the opposite substrate and comprising a plurality of second sub-pixel filter patterns and a second isolation structure, wherein each of the first bump comprises the first isolation structure and the second isolation structure stacked on each other; and
a third color resist, located on the opposite substrate and comprises a plurality of third sub-pixel filter patterns.

9. The liquid crystal display panel according to claim 8, wherein: the third color resist further comprises a third isolation structure, and the first bump comprises the first isolation structure, the second isolation structure and the third isolation structure stacked on one another.

10. The liquid crystal display panel according to claim 9, wherein
a distance between an end of the first isolation structure and a corresponding end of the second isolation structure is equal to a distance between an end of each of the plurality of first sub-pixel filter patterns and a corresponding end of a corresponding second sub-pixel filter pattern, and
a distance between an end of the second isolation structure and a corresponding end of the third isolation structure is equal to a distance between an end of each of the plurality of second sub-pixel filter patterns and a corresponding end of a corresponding third sub-pixel filter pattern.

11. The liquid crystal display panel according to claim 1, wherein the first inorganic transparent insulating layer comprises silicon nitride or silicon oxide.
